(19) United States
(12) Patent Application Publication
(10) Pub. No.: US 2025/0181398 A1
(43) Pub. Date: Jun. 5, 2025

(54) SYNCHRONOUS TO ASYNCHRONOUS DIGITAL SERVICE CALL CONVERSION

(71) Applicant: Adobe Inc., San Jose, CA (US)

(72) Inventors: Adrian John O'Lenskie, Dunblane (GB); Francesco Burato, Juniper Green (GB)

(73) Assignee: Adobe Inc., San Jose, CA (US)

(21) Appl. No.: 18/527,820

(22) Filed: Dec. 4, 2023

(51) Int. Cl. G06F 9/50

(52) U.S. Cl. CPC G06F 9/5027

(57) ABSTRACT

Synchronous to asynchronous digital service call conversion techniques are described. In one or more examples, a request is received at an interface module of the digital service infrastructure and a call ID is generated. A client timeout value from the request is used to set a timer. If client timeout value expires during processing of the request payload, the call ID is stored in a storage device and a timeout response is generated including the call ID for communication to the client device. A result payload is generated upon completion of the processing of the request payload by the execution module. The client device generates a continuation request which includes the call ID to obtain the result payload. The interface module utilizes the call ID to obtain the result payload from the storage device, which is then communicated as a continuation response back to the client device.

### BACKGROUND

Digital services are used to support an ever-increasing variety of functionalities, examples of which include social media services, digital content creation services, digital content streaming services, and so on. Consequently, the amount of computing devices consumed in support of this variety also continues to increase. In some scenarios, however, the amount of computational resources consumed as part of access by a client device causes inefficiencies both by a service provider system that implements the digital services as well as by the client device, itself.

### SUMMARY

Synchronous to asynchronous digital service call conversion techniques are described. In one or more examples, a request is received from a client device at an interface module of the digital service infrastructure. The interface module generates a call identifier and set a timer based on a client timeout value included in the request. The request payload is communicated by the interface module to an execution module to begin processing.

In a scenario in which the client timeout value expires during processing of the request payload by the execution module, a timeout elapsed notification is generated by the timer and passed to the interface module. This notification causes the interface module to store the call identifier in a storage device. The interface module also generates a timeout response including the call identifier for communication to the client device.

During these operations, a result payload is generated upon completion of the processing of the request payload by the execution module. The result payload is communicated from the execution module to the interface module, which is then stored in the storage device as indexed by the call identifier. The client device generates a continuation request which includes the call identifier to obtain the result payload. The interface module, upon receipt of the continuation request, utilizes the call identifier to obtain the result payload from the storage device, which is then communicated as a continuation response back to the client device. The result payload is then usable by the client device to continue processing in an asynchronous scenario.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of a digital medium environment in an example implementation that is operable to employ synchronous to asynchronous digital service call conversion processing techniques described herein.

FIG. 2 depicts a system in an example implementation depicting a digital service infrastructure of FIG. 1 in greater detail.

FIG. 3 depicts a system in an example implementation showing operation of the interface module of FIG. 1 in greater detail as receiving a request from a client device and subsequent processing of the request by an execution module.

FIG. 4 depicts a system in an example implementation showing operation of the interface module and the execution module of FIG. 2 in greater detail in response to expiration of a client timeout value.

FIG. 5 depicts a system in an example implementation showing operation of the execution module as generating a result payload based on the request payload and storage of the result payload in a storage device by the interface module.

FIG. 6 depicts a system in an example implementation showing operation of the interface module and client device as supporting asynchronous communication to communicate the result payload in response to a subsequent request received form the client device.

FIG. 7 depicts an example of a state diagram showing data flow as described in relation to FIGS. 3-6.

FIG. 8 is a flow diagram depicting an algorithm as a step-by-step procedure in an example implementation of operations performable for accomplishing a result of receiving a request from a client device and routing portions of the request as part of asynchronous digital service call conversion.

FIG. 9 is a flow diagram depicting an algorithm as a step-by-step procedure in an example implementation of operations performable for accomplishing a result of determining a timeout value has elapsed, continued processing of the request payload, and storage of a result payload as part of asynchronous digital service call conversion.

FIG. 10 is a flow diagram depicting an algorithm as a step-by-step procedure in an example implementation of operations performable for accomplishing a result of generating a request by a client device and receiving a response to the request as part of asynchronous communication between the client device and a service provider system.

FIG. 11 illustrates an example system including various components of an example device that can be implemented as any type of computing device as described and/or utilize with reference to FIGS. 1-10 to implement embodiments of the techniques described herein.

### DETAILED DESCRIPTION

### Overview

Digital services are tasked with providing ever increasing functionalities that consume corresponding ever-increasing amounts of computational resources by service provider systems that implement the digital services. Because of this, scenarios occur in which the amount of computational resources consumed also takes a significant amount of time to perform a requested action. Consequently, inefficiencies may occur in these scenarios.

A client device, for instance, in a conventional scenario communicates a request to a service provider system to perform a desired action. The request is synchronous in this example in that the request is performed in real time and the client device waits for a response. If that action is not performed by the service provider system in a specified amount of time as desired by the client device, however, the client device may “drop” the request. Conventionally, the client device then resubmits the request to the service provider system to try again using a second request. As a result, the computational resources used in the initial request are wasted as the service provider system is then again tasked with addressing the second request, thereby hindering operation of computing devices that implement the service provider system as well as increased power consumption.

Accordingly, techniques are described that support conversion of requests from client devices by a service provider system from synchronous communication to asynchronous communication. These techniques are configurable with existing infrastructures in one or more examples without involving changes at the client side. In this way, the service provider system addresses conventional technical challenges to improve computational resource consumption efficiency and reduce power consumption.

In one or more examples, a client device communicates a request to a service provider system via a network, e.g., to access a digital service implemented by the service provider system. The request, for instance, is configured as a POST request in compliance with a hypertext transfer protocol (HTTP) and includes a request payload that is a subject of an action to be performed for processing by the service provider system.

An interface module of the service provider system receives the request, and in response, generates a call identifier (ID) that uniquely identifies the request. The request in this example also includes a client timeout value that is specified by the client device indicating an amount of time that, once expired, the request is considered to “time out” by the client device. Accordingly, the interface module starts a timer using the client timeout value and forwards the request payload to an execution module for execution, which may involve load balancing techniques for selection of the execution module.

In this example, the client timeout value elapses during processing of the request payload by the execution module. The interface module, for instance, receives an indication of “timeout elapsed” from the timer. In response, the interface module stores the call ID in a storage device and communicates a timeout response having the call ID to the client device. During these operations, the execution module continues to process the request payload to generate a corresponding result payload. Once processing is completed, the result payload is passed from the execution module to the interface module, which is then stored in the storage device as indexed by the call ID.

The client device generates a continuation request that includes the call ID, which is received by the interface module. The interface module utilizes the call ID to locate the result payload from the storage device. If the execution server has not completed processing and therefore the result payload is not available, a response (e.g., HTTP 404 response) is returned to the client device. If the result payload is available, the result payload is then communicated back from the interface module to the client device in a continuation response. In this way, processing of the request payload continues by the execution module and avoids the “start and start again” technical challenges of conventional synchronous techniques by implementing the processing of the request asynchronously. As a result, the techniques described herein support increased computational resource efficiency, improve computing device operation, and reduce power consumption. Further discussion of these and other examples is included in the following sections and shown in corresponding figures.

In the following discussion, an example environment is described that employs the synchronous to asynchronous conversion processing techniques described herein. Example procedures are also described that are performable in the example environment as well as other environments. Consequently, performance of the example procedures is not limited to the example environment and the example environment is not limited to performance of the example procedures.

### Example Digital Service Call Environment

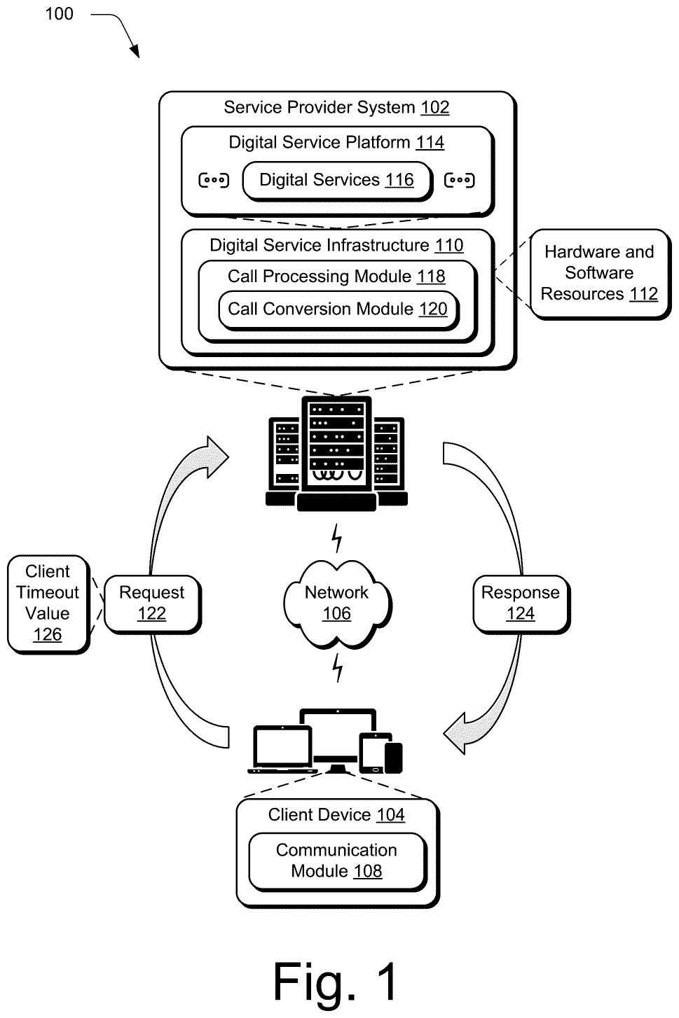

FIG. 1 is an illustration of a digital medium environment 100 in an example implementation that is operable to employ synchronous to asynchronous digital service call conversion processing techniques described herein. The illustrated environment 100 includes a service provider system 102 and a client device 104 that are communicatively coupled, one to another, via a network 106. Computing devices that implement the service provider system 102 and the client device 104 are configurable in a variety of ways.

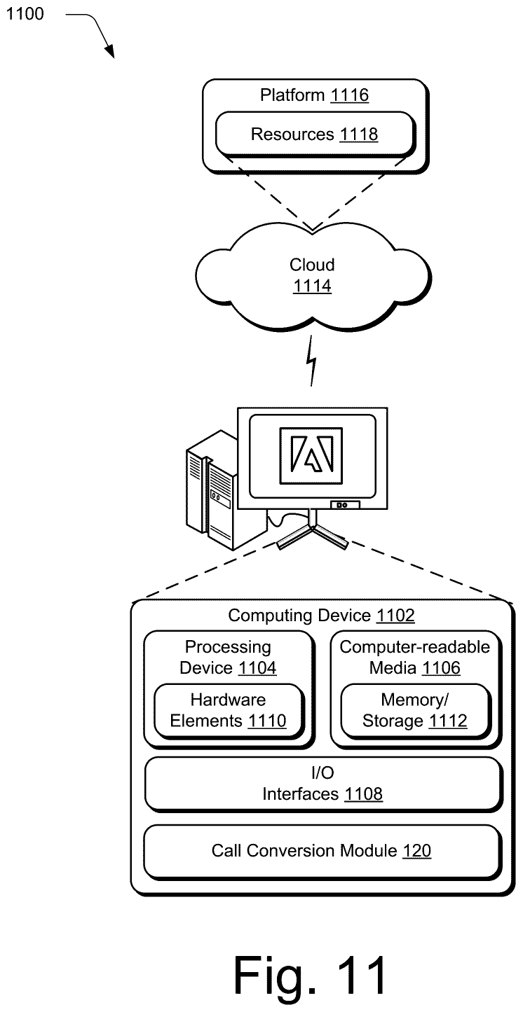

A computing device, for instance, is configurable as a desktop computer, a laptop computer, a mobile device (e.g., assuming a handheld configuration such as a tablet or mobile phone as illustrated), and so forth. Thus, a computing device ranges from full resource devices with substantial memory and processor resources (e.g., personal computers, game consoles) to a low-resource device with limited memory and/or processing resources (e.g., mobile devices). Additionally, although a single computing device is shown and described in some scenarios, a computing device is also representative of a plurality of different devices, such as multiple servers utilized by a business to perform operations “over the cloud” as described in FIG. 11, e.g., for the service provider system 102.

The client device 104 is illustrated as including a communication module 108. The communication module 108 is representative of hardware and software functionality of the client device 104 to access the network 106 and the service provider system 102 via the network 106. The communication module 108, for instance, is configurable as a browser or network-enabled application executed by a processing device of the client device 104. A variety of other instances are also contemplated.

The service provider system 102 includes a digital service infrastructure 110 implemented using hardware and software resources 112. The hardware and software resources 112 include servers, network connection devices, firewalls, and associated software that is configured to support communication via the network 106 as well as implement a digital service platform 114 to provision one or more digital services 116. Digital services 116 are executed as part of the digital service platform 114 in support of a variety of functionality, examples of which include social media services, websites, digital content streaming services, cloud computing, digital communication, data repositories, and so forth.

The digital service infrastructure 110 includes a call processing module 118 and call conversion module 120 that are implemented to handle “calls” to the one or more digital services 116 from the client device 104. The call processing module 118, for instance, is configured to receive a request 122 (e.g., as an HTTP request such as a GET request, a POST request, a PUT request, a DELETE request, a PATCH request, a HEAD request, a CONNECT request, an OPTIONS request, or a TRACE request), process the request 122 using the one or more digital services 116, and generate a response 124 to the request 122.

In conventional techniques, HTTP calls are handled synchronously. Accordingly, a client device that calls a digital service in a conventional scenario with a request waits for a response to then proceed with the results of that response. To protect against a “hang” or “deadlock” condition, the client device may employ a client timeout value, which defines an amount of time the client device is configured to wait to receive the response.

In complex digital service scenarios, execution of the services may involve complicated service topologies having a large number of dependencies between the services. Consequently, a call stack used to manage this execution may have a depth in these scenarios such that execution of the call stack is performed in an amount of time that exceeds the client timeout value. In conventional scenarios, this results in the client device “dropping” the call and reissuing the request, and consequently inefficient use of computational resources, network resources, and increased power consumption by both the client device and the service provider system.

In the techniques described herein, however, the call conversion module 120 is implemented to convert conventional synchronous management of calls to implement asynchronous performance. The client device 104, for instance, specifies a client timeout value 126 as part of the request 122. The client timeout value 126 specifies an amount of time the client device 104 is configured to wait for completion of performing an action specified in the request and to receive a response payload. Accordingly, the response 124 includes the response payload if processing by the execution module 204 is completed in time (e.g., an HTTP 200 response with the response payload) and the response is an HTTP 202 response that includes the call ID if processing has not been completed in time by the execution module 204.

Otherwise, if the client timeout value expires and the result of the processing is not available, the call conversion module 120 generates a call identifier (ID) that returned to the client device 104. The call identifier is then usable by the client device 104 to control when to fetch a response generated based on the request from the service provider system 102. In this way, the client device 104 is given control over a user experience in interaction with the service provider system 102 in support of a variety of functionalities.

The client device 104, for instance, is given flexibility to implement multiple continuation strategies depending on design constraints of functionality (e.g., a communication module 108) implemented at the client device 104. In a browser scenario, for instance, the call identifier is usable during a current session to define loading screens, for storage in local storage associated with the browser to implement a mailbox, may be persisted in a separate server to provide a multidevice mailbox capability, and so on. In a scenario in which the client device 104 is configured as a server, the call identifier is usable to model a polling mechanism, may be stored in support of event-based processing, and so forth. In this way, the call conversion module 120 addresses conventional technical challenges involved in long running HTTP requests by systematically converting synchronous requests for use in asynchronous processing. Further discussion of these and other examples is included in the following sections and shown in corresponding figures.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Synchronous to Asynchronous Call Conversion

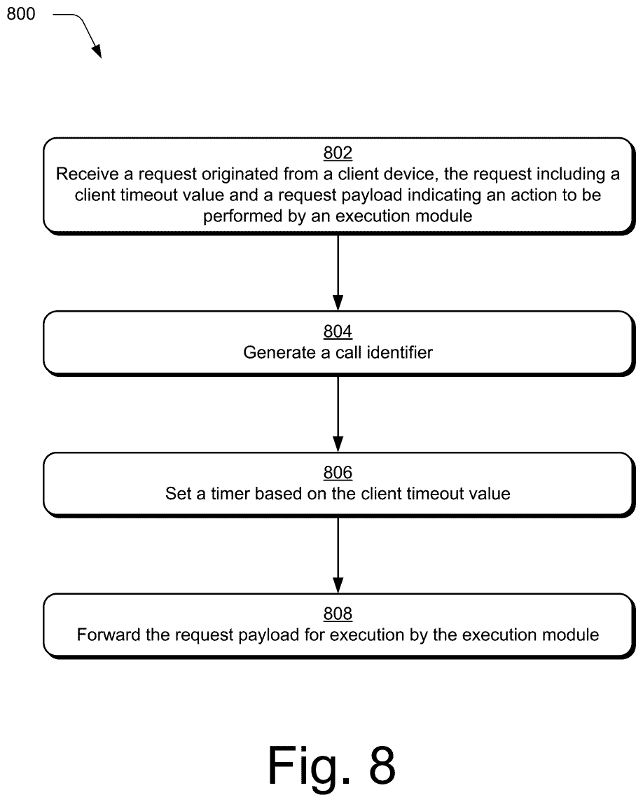

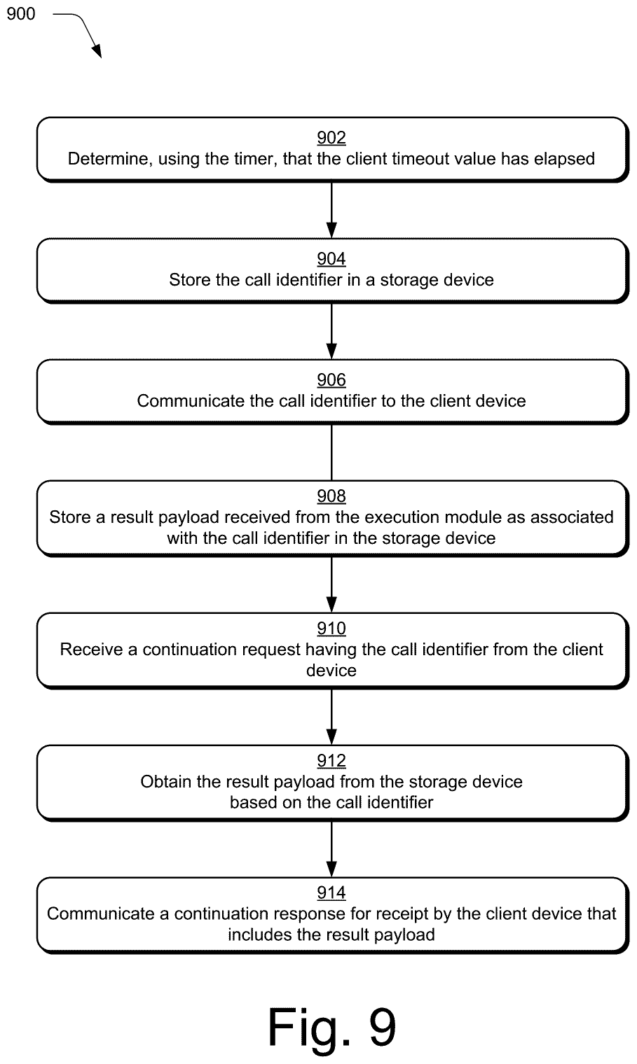

FIG. 8 is a flow diagram depicting an algorithm 800 as a step-by-step procedure in an example implementation of operations performable for accomplishing a result of receiving a request from a client device and routing portions of the request as part of asynchronous digital service call conversion. FIG. 9 is a flow diagram depicting an algorithm 900 as a step-by-step procedure in an example implementation of operations performable for accomplishing a result of determining a timeout value has elapsed, continued processing of the request payload, and storage of a result payload as part of asynchronous digital service call conversion. The following discussion describes call conversion techniques that are implementable utilizing the described systems and devices. Aspects of each of the procedures are implemented in hardware, firmware, software, or a combination thereof.

The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform algorithm. In portions of the following discussion, reference is made in parallel from FIGS. 1-7 to the procedures of FIGS. 8 and 9.

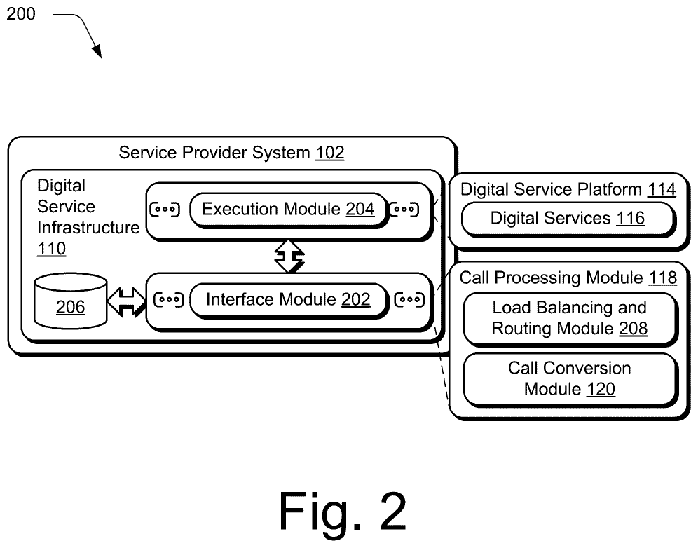

FIG. 2 depicts a system 200 in an example implementation depicting a digital service infrastructure 110 of FIG. 1 in greater detail. The digital service infrastructure 110 includes an interface module 202, an execution module 204, and a storage device 206.

The interface module 202 is representative of functionality of the digital service infrastructure 110 that is configured to receive the request 122, route the request 122 to a corresponding execution module 204, and route a response 124 including a result of processing by the execution module 204 to the client device 104. The interface module 202 and the execution module 204 may be implemented on a same device (e.g., same server), different devices (e.g., different servers), implemented “virtually,” and so forth. To do so, the interface module 202 includes a call processing module 118 that includes a load balancing and routing module 208 to implement load balancing techniques and maintain a call stack for processing the request 122. The interface module 202 also includes the call conversion module 120 to convert a synchronous request for implementation using asynchronous techniques.

The execution servicer 204 is representative of functionality of the digital service infrastructure 110 to implement the digital service platform 114 and respective one or more digital services 116. The execution module 204, for instance, is configurable as “backend” functionality that implements logic to process the request 122 to perform corresponding actions. The storage device 206 is representative of implementation of one or more computer-readable storage media configured to store data.

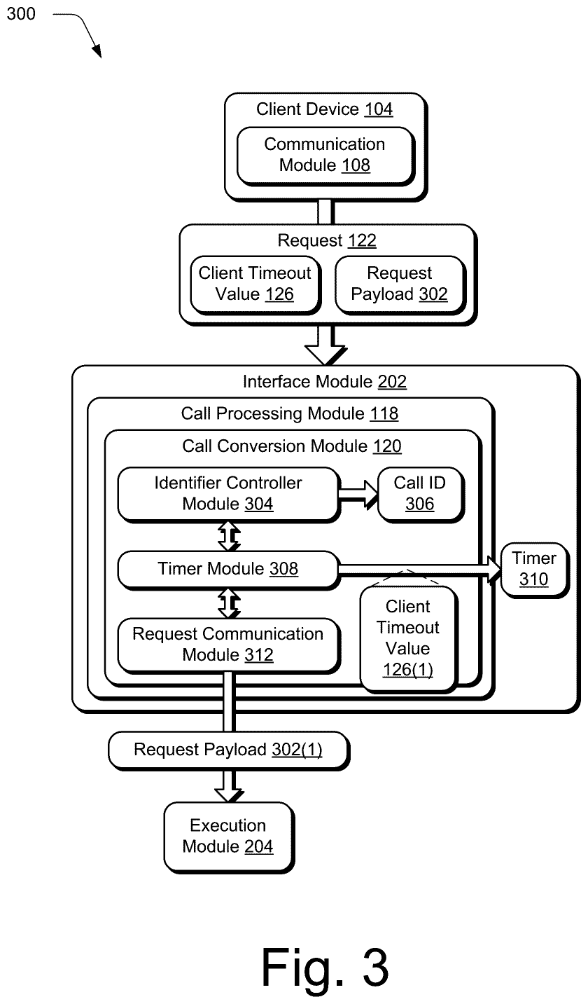

FIG. 3 depicts a system 300 in an example implementation showing operation of the interface module 202 of FIG. 1 in greater detail as receiving a request 122 from a client device 104 and subsequent processing of the request by an execution module 204. To begin in this example, a communication module 108 of the client device 104 generates a request 122. The request 122 includes a client timeout value 126 specifying an amount of time the client device 104 is configured to wait for a reply to the request 122, e.g., for processing a request payload 302 of the request 122. The request payload 302 identifies an action from the client device 104 and data to be used as part of processing the request 122 to perform the action. In an example, the request 122 is configured in accordance with one or more communication protocols, such as a hypertext transfer protocol. The request 122, for instance, is configurable as a “GET request” to retrieve data, a “POST request” to submit data for processing, or a “PUT request” to update an existing resource of the one or more digital services 116.

The request 122 originated from the client device 104 is then received at an interface module 202. The request 122 includes the client timeout value 126 (block 802) as described above, and as such provides an ability of the client device 104 to control processing performed by the service provider system 102, which is not possible in conventional techniques.

In response, the call conversion module 120 employs an identifier controller module 304 to generate a call identifier (block 804), illustrated as call ID 306. The call ID 306 is generated to uniquely identify the request 122 and associated processing to the interface module 202.

A timer module 308 is also employed to set a timer 310 based on the client timeout value 126(1) (block 806). In the following discussion, a numbering convention is used in which parentheticals and associated numbers are used to depict successive instances of corresponding data in a corresponding figure, e.g., client timeout value 126 included as part of the request 122 and client timeout value 126(1) as used by the timer module 308 to set the timer 310.

A request communication module 312 is utilized by the call conversion module 120 to forward the request payload 302(1) as received in the request 122 for processing by an execution module 204 (block 808). The request communication module 312, for instance, is usable to locate functionality to process the request 122 from the one or more digital services 116, implement load balancing, and so forth. Accordingly, in this example, the interface module 202 has received and processed the request 122 to initiate processing of the request payload 302(1) by the execution module 204.

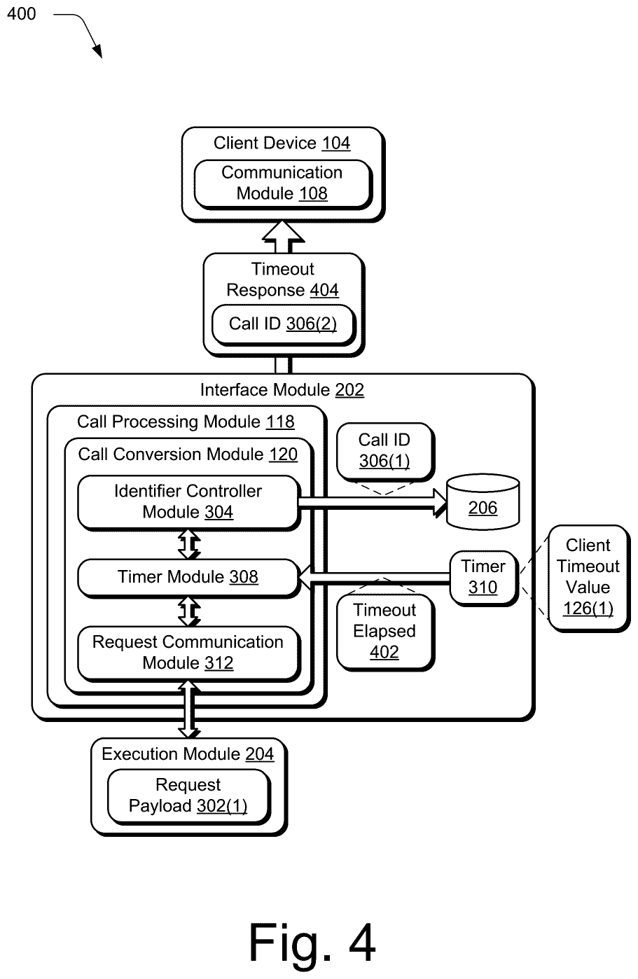

FIG. 4 depicts a system 400 in an example implementation showing operation of the interface module 202 and the execution module 204 of FIG. 2 in greater detail in response to expiration of client timeout value. As described above, the interface module 202 is configured to generate a response 124 that includes the response payload if processing by the execution module 204 is completed in time, e.g., an HTTP 200 response with the response payload. The interface module 202 is also configured to generate the response 124 as an HTTP 202 response with the call ID in a scenario in which processing has not been completed in time by the execution module 204.

In this example, processing of the request payload 302(1) continues by the execution module 204. During this processing, a client timeout value 126(1) set by the timer 310 expires. The timer 310, in response, communicates a timeout elapsed 502 notification to the timer module 308 of the call conversion module 120.

Based on the timeout elapsed 502 notification received from the timer 310, the timer module 308 of the call conversion module 120 determines that the client timeout value 126(1) has elapsed (block 902) and proceeds accordingly. The call conversion module 120, for instance, stores the call ID 306(1) in a storage device 206 (block 904). Other examples are also contemplated, e.g., in which the identifier controller module 304 stores the call ID 306(1) when generated in the storage device 206.

The call conversion module 120 also utilizes the identifier controller module 304 to generate a timeout response 404 to communicate the call ID 306(2) to the client device 104 (block 906). The timeout response 404, for instance, is configurable as part of an “HTTP 202” status code that indicates the request 122 has been accepted by the interface module 202 for processing. Additional implementations are also contemplated, e.g., in which the call ID 306(2) is communicated upon generation by the identifier controller module 304 and before the client timeout value 126(1) has elapsed. In this additional implementation, therefore, the client device 104 is configured to react when the client timeout value 126(1) is reached internally by the client device 104 without further communication with the interface module 202. As described above, the execution module 204 continues to process the request payload 302(1) during the countdown and expiration of the client timeout value 126(1) by the timer 310, the storage of the call ID 206(1) in the storage device 206, and the generation and communication of the timeout response 404 including the call ID 306(2) to the client device 104.

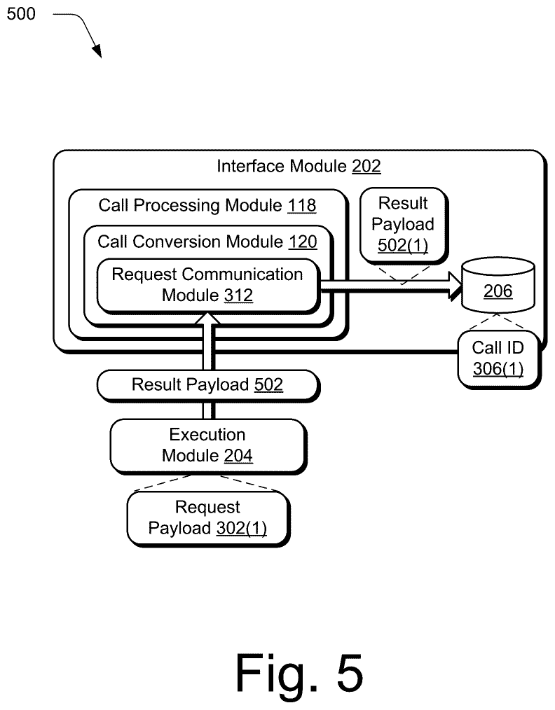

FIG. 5 depicts a system 500 in an example implementation showing operation of the execution module 204 as generating a result payload based on the request payload and storage of the result payload in a storage device by the interface module 202. The execution module 204 in this example completes processing of the request payload 302(1), e.g., as part of implementing the one or more digital services 116.

The processing results in generation of a result payload 502 that is to be communicated back to the client device 104 in the response 124. The result payload 502 may take a variety of forms based on the actions and corresponding digital services 116 that are implemented by the execution module 204. The result payload 502, for instance, may be generated in support of social media services, websites, digital content streaming services, cloud computing, digital communication, data repositories, and so forth. The result payload 502(1) received by the interface module 202 from the execution module 204 is then stored as associated with a call ID 306(1) in the storage device 206 (block 908). The call ID 306(1), for instance, is configurable as an index to locate the result payload 502(1).

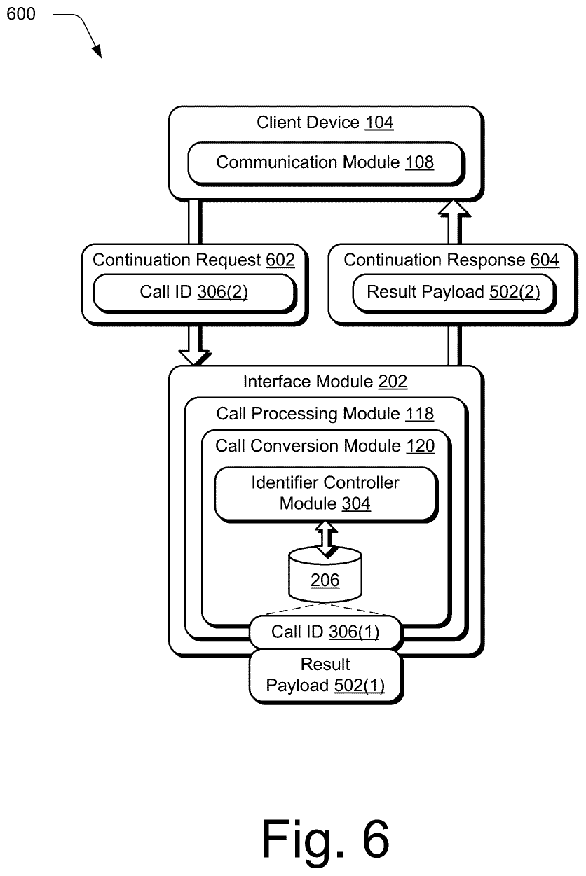

FIG. 6 depicts a system 600 in an example implementation showing operation of the interface module 202 and client device 104 as supporting asynchronous communication to communicate the result payload 502(1) in response to a subsequent request received form the client device 104. Continuing with the example of FIG. 4, the client device 104 receives the timeout response 404 having the call ID 306(2). Accordingly, the client device 104 is made aware that the response 124 including the result payload 502 is not available at that time. Therefore, the client device 104 implements functionality to obtain the result payload 502 at a later point in time using one or more continuation strategies, e.g., to wait an additional amount of time, immediately request the result payload 502, and so forth.

Based on the continuation strategy employed, the client device 104 generates a continuation request 602, which is received by the interface module 202 and includes the call ID 306(2) (block 910). The identifier controller module 304 of the call conversion module 120 then utilizes the call ID 306(2) as an index to locate the call ID 306(1) in the storage device 206 and obtain the result payload 502(1) (block 912). A communication is then generated as a continuation response 604 in the illustrated example to communicate the result payload 502(2) back to the client device 104 (block 914), e.g., as an HTTP 202 response with the call ID.

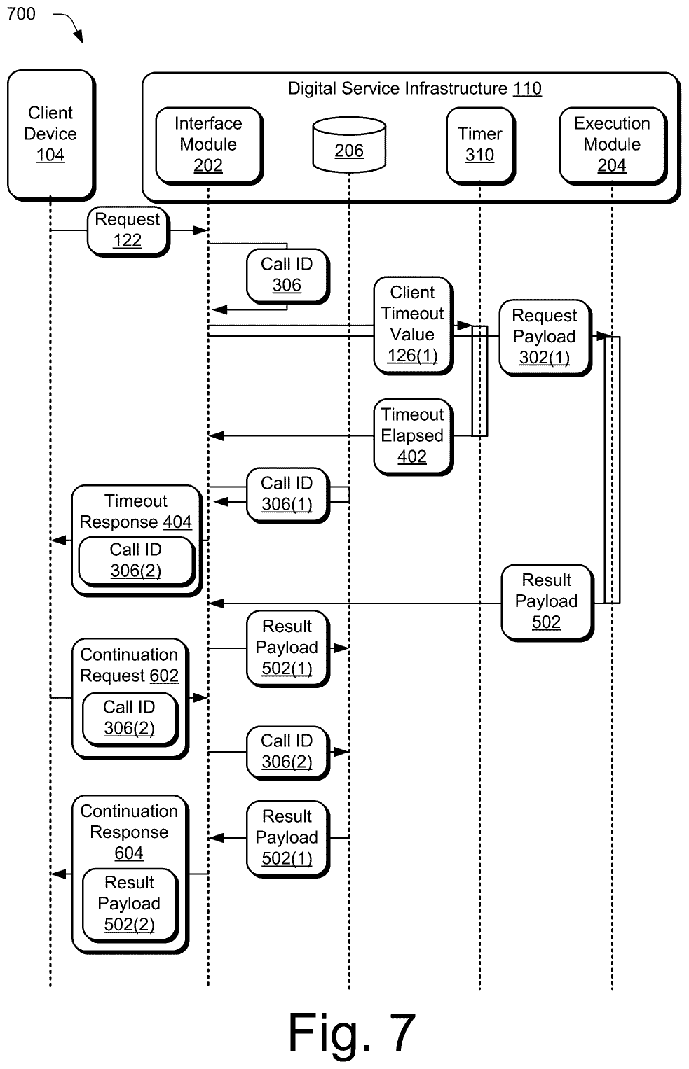

FIG. 7 depicts an example of a state diagram 700 showing data flow as described in relation to FIGS. 3-6. The statue diagram 700 begins with communication of a request 122 from a client device 104 to an interface module 202 of the digital service infrastructure 110. The interface module 202 generates a call ID 306. The client timeout value 126(1) is communicated by the interface module 202 to set the timer 310 and the request payload 302(1) is communicated to the execution module 204 to begin processing.

In the illustrated example, the client timeout value 126(1) expires during processing of the request payload 302(1) by the execution module 204. Accordingly, a timeout elapsed 402 notification is generated and passed to the interface module 202. This causes the interface module 202 to store a call ID 206(1) in storage device 206 and also generate a timeout response 404 including the call ID 206(2) for communication to the client device 104, e.g., via the network 106.

A result payload 502 is generated upon completion of the processing of the request payload 302(1) by the execution module 204. The result payload 302(1) is generated as a result of processing by the execution module that is performed concurrently with the operations described above for the interface module 202. The result payload 502 is communicated from the execution module 204 to the interface module 202, which is then stored in the storage device 206 prior to receipt of a request from the client device 104 for access.

The client device 104 generates a continuation request 602 which includes the call ID 306(2) to obtain the result payload 502. The interface module 202, upon receipt of the continuation request 602, utilizes the call ID 206(2) to obtain the result payload 502(1) from the storage device 206, which is then communicated as a continuation response 604 back to the client device 104 as the result payload 502(2). The result payload 502(2) is then usable by the client device 104 to continue processing in an asynchronous scenario.

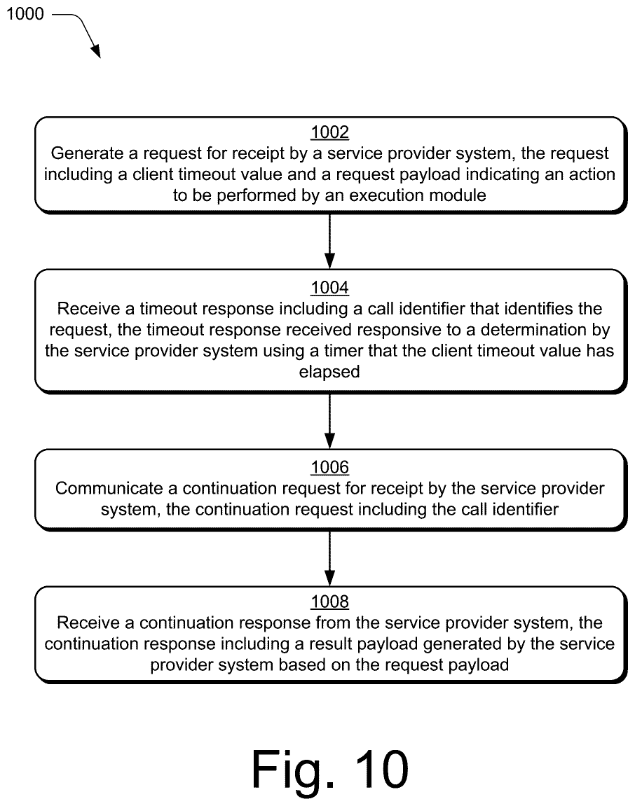

FIG. 10 is a flow diagram depicting an algorithm 1000 as a step-by-step procedure in an example implementation of operations performable for accomplishing a result of generating a request by a client device and receiving a response to the request as part of asynchronous communication between the client device and a service provider system. In this example, operations are described that are performed from the “client side” in the above example.

To begin, a request is generated for receipt by a service provider system. The request includes a client timeout value and a request payload indicating an action to be performed by an execution module (block 1002). A timeout response is received including a call identifier that identifies the request, the timeout response received responsive to a determination by the service provider system using a timer that the client timeout value has elapsed (block 1004).

A continuation request is generated for receipt by the service provider system. The continuation request includes the call identifier (block 1006). A continuation response is then received from the service provider system. The continuation response including a result payload generated by the service provider system based on the request payload (block 1008).

### Example System and Device

FIG. 11 illustrates an example system generally at 1100 that includes an example computing device 1102 that is representative of one or more computing systems and/or devices that implement the various techniques described herein. This is illustrated through inclusion of the call conversion module 120. The computing device 1102 is configurable, for example, as a server of a service provider, a device associated with a client (e.g., a client device), an on-chip system, and/or any other suitable computing device or computing system.

The example computing device 1102 as illustrated includes a processing device 1104, one or more computer-readable media 1106, and one or more I/O interface 1108 that are communicatively coupled, one to another. Although not shown, the computing device 1102 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing device 1104 is representative of functionality to perform one or more operations using hardware. Accordingly, the processing device 1104 is illustrated as including hardware element 1110 that is configurable as processors, functional blocks, and so forth. This includes implementation in hardware as an application specific integrated circuit or other logic device formed using one or more semiconductors. The hardware elements 1110 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 1106 is illustrated as including memory/storage 1112 that stores instructions that are executable to cause the processing device 1104 to perform operations. The memory/storage 1112 represents memory/storage capacity associated with one or more computer-readable media. The memory/storage 1112 includes volatile media (such as random access memory (RAM)) and/or nonvolatile media (such as read only memory (ROM), Flash memory, optical disks, magnetic disks, and so forth). The memory/storage 1112 includes fixed media (e.g., RAM, ROM, a fixed hard drive, and so on) as well as removable media (e.g., Flash memory, a removable hard drive, an optical disc, and so forth). The computer-readable media 1106 is configurable in a variety of other ways as further described below.

Input/output interface(s) 1108 are representative of functionality to allow a user to enter commands and information to computing device 1102, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1102 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 1102. By way of example, and not limitation, computer-readable media includes “computer-readable storage media” and “computer-readable signal media.”

“Computer-readable storage media” refers to media and/or devices that enable persistent and/or non-transitory storage of information (e.g., instructions are stored thereon that are executable by a processing device) in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 1102, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1110 and computer-readable media 1106 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 1110. The computing device 1102 is configured to implement particular instructions and/or functions corresponding to the software and/or hardware modules. Accordingly, implementation of a module that is executable by the computing device 1102 as software is achieved at least partially in hardware, e.g., through use of computer-readable storage media and/or hardware elements 1110 of the processing device 1104. The instructions and/or functions are executable/operable by one or more articles of manufacture (for example, one or more computing devices 1102 and/or processing devices 1104) to implement techniques, modules, and examples described herein.

The techniques described herein are supported by various configurations of the computing device 1102 and are not limited to the specific examples of the techniques described herein. This functionality is also implementable all or in part through use of a distributed system, such as over a “cloud” 1114 via a platform 1116 as described below.

The cloud 1114 includes and/or is representative of a platform 1116 for resources 1118. The platform 1116 abstracts underlying functionality of hardware (e.g., servers) and software resources of the cloud 1114. The resources 1118 include applications and/or data that can be utilized while computer processing is executed on servers that are remote from the computing device 1102. Resources 1118 can also include services provided over the Internet and/or through a subscriber network, such as a cellular or Wi-Fi network.

The platform 1116 abstracts resources and functions to connect the computing device 1102 with other computing devices. The platform 1116 also serves to abstract scaling of resources to provide a corresponding level of scale to encountered demand for the resources 1118 that are implemented via the platform 1116. Accordingly, in an interconnected device embodiment, implementation of functionality described herein is distributable throughout the system 1100. For example, the functionality is implementable in part on the computing device 1102 as well as via the platform 1116 that abstracts the functionality of the cloud 1114.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
receiving, by a processing device, a request originated from a client device, the request including a client timeout value and a request payload indicating an action to be performed by an execution module;
determining, by the processing device, using a timer that the client timeout value has elapsed;
communicating, by the processing device, a timeout response for receipt by the client device, the timeout response including a call identifier that identifies the request;
storing, by the processing device, a result payload in a storage device, the result payload generated by the execution module based on the request payload;
receiving, by the processing device, a continuation request from the client device having the call identifier;
obtaining, by the processing device, the result payload from the storage device based on the call identifier; and
communicating, by the processing device, a continuation response for receipt by the client device, the continuation response including the result payload.

2. The method as described in claim 1, wherein the request, the timeout response, the continuation request, and the continuation response are configured in compliance with a hypertext transfer protocol (HTTP).

3. The method as described in claim 2, wherein the request is a GET request, a POST request, a PUT request, a DELETE request, a PATCH request, a HEAD request, a CONNECT request, an OPTIONS request, or a TRACE request.

4. The method as described in claim 2, wherein the continuation request is a GET request.

5. The method as described in claim 1, wherein the storing of the result payload is performed subsequent to the communicating of the timeout response.

6. The method as described in claim 5, wherein the storing of the result payload is performed prior to the receiving of the continuation request from the client device having the call identifier.

7. The method as described in claim 6, wherein the continuation response is configured as a hypertext transfer protocol (HTTP) response.

8. The method as described in claim 1, further comprising processing the request payload by the execution module concurrently with the determining that the client timeout value has elapsed and the communicating of the timeout response for receipt by the client device.

9. The method as described in claim 1, further comprising generating, by the processing device, the call identifier as identifying the request.

10. A client device comprising:
a processing device; and
a computer-readable storage medium storing instructions that, responsive to execution by the processing device, causes the processing device to perform operations including:
generating a request for receipt by a service provider system, the request including a client timeout value and a request payload indicating an action to be performed by an execution module;
receiving a timeout response including a call identifier that identifies the request, the timeout response received responsive to a determination by the service provider system using a timer that the client timeout value has elapsed;
communicating a continuation request for receive by the service provider system, the continuation request including the call identifier; and
receiving a continuation response from the service provider system, the continuation response including a result payload generated by the service provider system based on the request payload.

11. The client device as described in claim 10, wherein the request, the timeout response, the continuation request, and the continuation response are configured in compliance with a hypertext transfer protocol (HTTP).

12. The client device as described in claim 11, wherein the request is a POST request and the continuation request is a GET request.

13. The client device as described in claim 10, wherein the call identifier is generated by the service provider system.

14. The client device as described in claim 10, wherein the continuation request is configured to cause the service provider system to locate the result payload from a storage device based on the call identifier, the result payload stored subsequent to processing of the request payload by an execution module as performing an action specified by the request.

15. A system comprising:
an interface module configured to:
receive a request from a client device, the request including a client timeout value and a request payload;
communicate the request payload to an execution module;
communicate a timeout response for receipt by the client device responsive to expiration of the client timeout value, the timeout response including a call identifier that identifies the request;
receive a continuation request from the client device having the call identifier; and
communicate a continuation response for receipt by the client device, the continuation response including a result payload; and
the execution module configured to generate the result payload by executing an action specified in the request based on the request payload.

16. The system as described in claim 15, wherein the interface module is configured to:
receive the result payload from the execution module; and
cause the result payload to be stored in a storage device as associated with the call identifier.

17. The system as described in claim 16, wherein the interface module is configured to obtain the result payload from the storage device responsive to the continuation request based on the call identifier.

18. The system as described in claim 15, wherein the request, the timeout response, the continuation request, and the continuation response are configured in compliance with a hypertext transfer protocol (HTTP).

19. The system as described in claim 15, wherein the interface module is configured to generate the call identifier.

20. The system as described in claim 15, wherein the interface module is configured to set a timer based on the client timeout value.
